(19) United States
(12) Patent Application Publication
(10) Pub. No.: US 2007/0074141 A1
(43) Pub. Date: Mar. 29, 2007

(54) Simulation apparatus and simulation method

(75) Inventor: Tsutomu Takei, Yokohama-shi (JP)

Correspondence Address: BANNER & WITCOFF, LTD., ATTORNEYS FOR RESERVE;ATTORNEYS FOR CLIENT NO. 000449, 001701, 1001 G STREET, N.W., 11TH FLOOR, WASHINGTON, DC, 20001-4597, US

(73) Assignee: KABUSHIKI KAISHA TOSHIBA, Minato-ku (JP)

(21) Appl. No.: 11/527,418

(22) Filed: Sep. 27, 2006

(30) Foreign Application Priority Data
Sep. 27, 2005 (JP) 2005-280862

(51) Int. Cl. G06F 17/50

(52) U.S. Cl. 716/18; 716/5; 703/16

(57) ABSTRACT

According to an aspect of the invention, a simulation apparatus includes: a computer configured to execute a program which is formed as an operating description having no temporal restriction; and a programmable circuit configured to be on which a designing object circuit configured to perform a cycle operation is mounted. The programmable circuit includes; a data transfer circuit configured to transfer data between the computer and the designing subject circuit in a unit of a transaction; a verification circuit configured to verify as to whether or not operation of the designing subject circuit satisfies a specification and notifying a detection of an error when the operation of the designing subject circuit does not satisfy the specification; and a verification result transfer circuit configured to temporarily stop the operation of the designing subject circuit in the case that the detection of the error is notified so as to transfer a verification result obtained by the verification circuit to the computer.

### CROSS-REFERENCE TO RELATED APPLICATIONS

This application is based upon and claims the benefit of priority from the prior Japanese Patent Applications No. 2005-280862, filed on Sep. 27, 2005; the entire contents of which are incorporated by reference.

### BACKGROUND OF THE INVENTION

1. Technical Field

The present invention is related to a simulation apparatus and a simulation method, which are used in a cooperative simulation of a transaction level.

2. Related Art

While large-scaled and complex system LSIs (SoC: System on a Chip) are designed, time and workloads required for simulations are increased. Also, in order to improve all-inclusive characteristics of verifications, the verifications must be carried in high speeds; the verifications must be carried out in design upstreams; and the system LSIs must be verified by being connected to actual appliances and designing resources (Intellectual Proprietary: IP). On the other hand, there are some cases that a plurality of assertions are inserted into circuit descriptions described by using hardware description languages (HDL) of register transfer levels (RTL), or the like, in order to verify as to whether or not the above-explained circuit descriptions can satisfy specifications (refer to, for example, JP-A-2005-108007) The term “assertion” implies a method for forming a program having no error. In this “assertion” method, a verification-purpose code (assertion description) is inserted in a place within a program, in which a certain condition must be established, and then, in such a case that the condition is violated, an error is outputted, so that a status of the program can be checked. In the case that the assertion is utilized, an assertion verification by an HDL simulator is executed on a computer.

Moreover, as a purpose capable of performing verifications in high speeds, such simulations are utilized with employment of programmable circuits such as a field programmable gate array (FPGA). In system LSIs, a function which is intended to be realized as hardware is loaded on an FPGA, whereas a function which is not intended to be realized as hardware is executed by a computer by employing a C/C++ language, or the like. A simulation as to both software and hardware using a programmable circuit and a computer is referred to as a “cooperative simulation.”

However, in the above-explained cooperative simulation, the simulation containing the assertion cannot be carried out with respect to a designing subject circuit which is mounted on a programmable circuit. As a result, monitoring characteristics as to internal operations (internal signals) of the designing subject circuit which is mounted on the programmable circuit is low, and thus, simulation qualities cannot be sufficiently increased.

### SUMMARY

According to one aspect of the invention, there is provided a simulation apparatus includes: a computer configured to execute a program which is formed as an operating description having no temporal restriction; and a programmable circuit configured to be on which a designing object circuit configured to perform a cycle operation is mounted. The programmable circuit includes; a data transfer circuit configured to transfer data between the computer and the designing subject circuit in a unit of a transaction; a verification circuit configured to verify as to whether or not operation of the designing subject circuit satisfies a specification and notifying a detection of an error when the operation of the designing subject circuit does not satisfy the specification; and a verification result transfer circuit configured to temporarily stop the operation of the designing subject circuit in the case that the detection of the error is notified so as to transfer a verification result obtained by the verification circuit to the computer.

According to another aspect of the present invention, there is provided a simulation method comprising: mounting a designing subject circuit which performs a cycle operation on a programmable circuit; executing a program which is formed as an operating description having no temporal restriction on a computer; transferring data between the computer and the designing subject circuit in the unit of a transaction; verifying as to whether or not operation of the designing subject circuit satisfies a specification; notifying a detection of an error in the case that the operation of the designing subject circuit does not satisfy the specification; and stopping the operation of the designing subject circuit temporarily in case that the detection of the error is notified; and transfer to the computer, a result of the verification for indicating as to whether or not the operation of the designing subject circuit satisfies the specification.

### BRIEF DESCRIPTION OF THE DRAWINGS

FIG. 1 is an exemplary block diagram for indicating an entire structural example of a simulation apparatus according to a first embodiment the present invention.

FIG. 2 is an exemplary schematic diagram showing an example of an assertion description (assertion property) used in a simulation method according to the first embodiment.

FIG. 3 is an exemplary schematic diagram showing an example of an assertion description (assertion designation) used in the simulation method according to the first embodiment.

FIG. 4 is an exemplary block diagram for indicating a partial structural example as to a programmable circuit according to the first embodiment.

FIG. 5 is an exemplary block diagram showing an internal structural example as to a first verification circuit according to the first embodiment.

FIG. 6 is an exemplary block diagram for showing an internal structural example as to a first verification result transfer circuit according to the first embodiment.

FIG. 7A-7D are exemplary time charts for explaining an operation example of the programmable circuit according to the first embodiment.

FIG. 8 is an exemplary flow chart for describing a process sequential example as to the simulation method according to the first embodiment.

FIG. 9 is an exemplary flow chart for indicating an example as to a simulation method according to a second modification of the first embodiment.

FIG. 10 is an exemplary flow chart for indicating an example as to a simulation method according to a third modification of the first embodiment.

FIG. 11 is an exemplary block diagram for indicating an entire structural example of a simulation apparatus according to a second embodiment of the present invention.

FIG. 12A-12D are exemplary time charts for explaining an operation example of a programmable circuit according to the second embodiment.

FIG. 13 is an exemplary block diagram for indicating an entire structural example of a simulation apparatus according to a third embodiment of the present invention.

FIG. 14 is an exemplary flow chart for indicating an example as to a simulation method according to the third embodiment.

### DESCRIPTION OF THE EMBODIMENTS

Referring now to drawings, embodiments of the present invention will be described. It should be understood that the same, or similar symbols will be employed for denoting the same, or similar components in drawings in the below-mentioned embodiments.

### First Embodiment

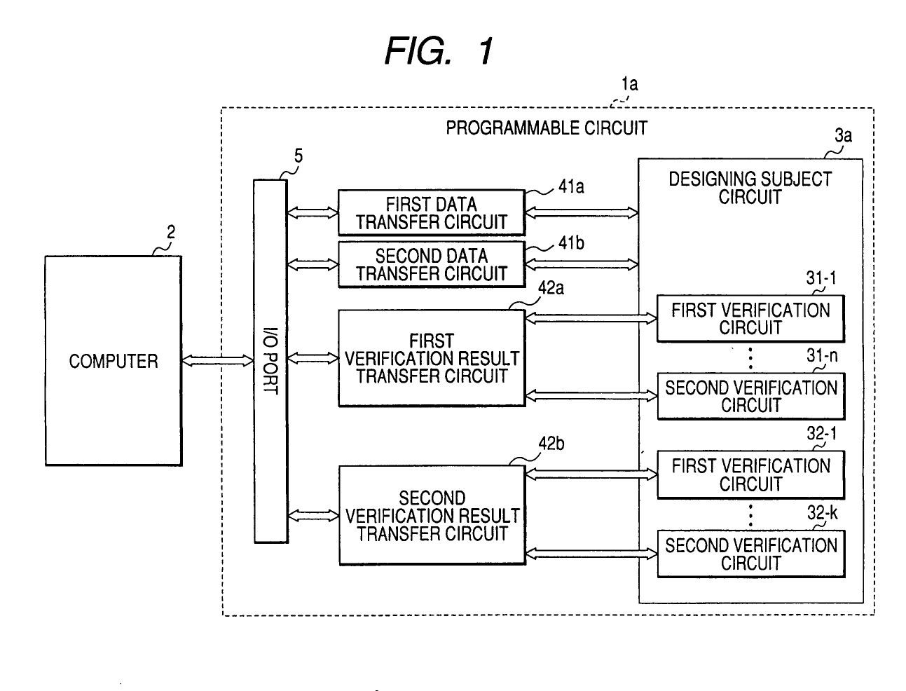

As represented in FIG. 1, a simulation apparatus, according to a first embodiment of the present invention, is provided with a programmable circuit 1a and a computer 2. A designing subject circuit 3a for performing a cycle operation is mounted on the programmable circuit 1a. The computer 2 executes a program which is formed as an operating description having no temporal restriction. In this case, the term “cycle operation” implies an operation which is synchronized with a clock. The term “no temporal restriction” implies an operation which is not synchronized with the clock. In the below-mentioned explanation, an operation having no temporal restriction will be referred to as a “temporally unlimited operation” hereinafter. As the programmable circuit 1a, for example, an FPGA (Field Programmable Gate Array) maybe used. Also, in the below-mentioned explanations, as a program which is executed by the computer 2, a description is made of such an example in which a program (will be abbreviated as “C/C++ program” hereinafter) is used, which has been described by either a C language or a C++ language. The “C/C++ program” corresponds to, for example, software which is cooperatively operated with the designing subject circuit 3a, and inputs data and outputs data with respect to the designing subject circuit 3a.

In the programmable circuit 1a, a first data transfer circuit 41a and a second data transfer circuit 41b; a first verification circuit 31_1; a first verification circuit 32_1; and a first verification result transfer circuit 42a are provided. The first and second data transfer circuits 41a and 41b transfer data between the computer 2 and the designing subject circuit 3a in the unit of a transaction. The first verification circuit 31_1 is provided in the designing subject circuit 3a, and verifies an assertion which indicates as to whether or not an internal operation of the designing subject circuit 3a can satisfy a specification. The first verification circuit 32_1 verifies as to whether or not operation of the designing subject circuit 3a can satisfy the specification, and notifies an error detection when the operation of the designing subject circuit 3a cannot satisfy the specification. The first verification result transfer circuit 42a temporarily stops the operation of the designing subject circuit 3a in such a case that the error detection is notified, and transfers the verification result by the first verification circuit 31_1 to the computer 2. The respective circuits employed in the programmable circuit 1a are arranged in response to circuit data acquired by logically combining HDL descriptions with each other. It should also be noted that the term “transaction” implies that a plurality of process operations which are related to each other are collected as one process unit.

As information about verification results transferred from the first verification result transfer circuit 42a to the computer 2, for instance, the following information may be conceived: presence/absence of an error detection; a value of a verifying subject signal when an error is detected; and information as to a total cycle number from a commencement of a simulation until an error is detected.

The first data transfer circuit 41a is employed when data is inputted with respect to an input terminal (omitted in drawing) of the designing subject circuit 3a, whereas the second data transfer circuit 41b is employed when data is outputted from an output terminal (omitted in drawing) of the designing subject circuit 3a. Both the first and second data transfer circuits 41a and 41b bridge the hardware (designing subject circuit 3a) operated in the cycle operation with respect to the software (C/C++ programs) executed in the temporally unlimited operation.

As a consequence, a data transfer operation between the hardware (designing subject circuit 3a) and the software (C/C++ programs) can be realized in the unit of a transaction (or in the unit of plural clocks). Every time the designing subject circuit 3a mounted on the programmable circuit 1a is continuously operated for approximately several tens of cycles to several hundreds of cycles, data is inputted and outputted between the computer 2 and the designing subject circuit 3a. As a result, a cooperative simulation can be carried out in a high speed and a time period required for the simulation can be shortened, as compared with such a method that every time the designing subject circuit 3a is operated for 1 cycle, a clock is stopped and data is inputted and outputted.

As shown in FIG. 1, in addition to the first verification result transfer circuit 42a, a second verification result transfer circuit 42b is mounted on the programmable circuit 1a. Total quantities as to data transfer circuits and verification result transfer circuits are not limited only to two pieces, but may be 3, or more pieces. Alternatively, while the first data transfer circuit 41a, the second data transfer circuit 41b, the first verification result transfer circuit 42a, and the second verification result transfer circuit 42b are mounted as a single state machine, the respective functions as to the first data transfer circuit 41a, the second data transfer circuit 41b, the first verification result transfer circuit 42a, and the second verification result transfer circuit 42b may be realized in the single state machine.

Furthermore, a plurality (first to “n”th) verification circuits 31_1 to 31_n, and a plurality (first to “k”th) verification circuits 32_1 to 32_k are mounted inside the designing subject circuit 3a (symbols “n” and “k” are 2, or more integers). The plural verification circuits 31_1 to 31_n notify verification results to the first verification result transfer circuit 42a, whereas the plural verification circuits 31_1 to 32_k notify verification results to the second verification result transfer circuit 42b.

The programmable circuit 1a is equipped with an input/output (I/O) port 5 connected to the computer 2. As the I/O port 5, for example, such an I/O port may be used which is adapted to the SCE-MI (Standard Co-Emulation Modeling Interface) standard corresponding to an interface standard used to verify a transaction level. The I/O port 5 is connected to the computer 2 via, for example, a PCI bus, or the like.

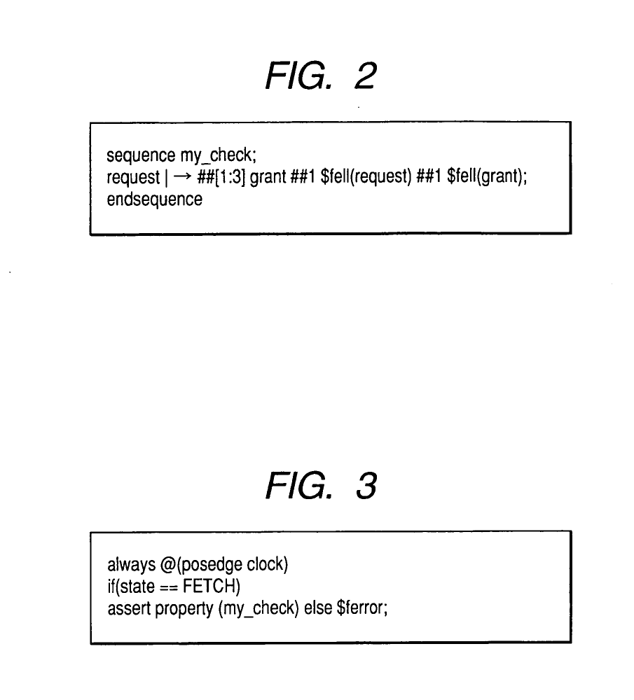

Each of the first verification circuit 31_1 to the nth verification circuit 31_n is constructed based upon assertion descriptions as indicated in FIG. 2 and FIG. 3. In other words, a total number of the first to nth verification circuits 31_1 to 31_n, and the first to kth verification circuits 32_1 to 32_k correspond to a total number of the assertion descriptions which are inserted into the HDL description. In the below-mentioned explanations, such a case is described that the first verification circuit 31_1 shown in FIG. 1 owns structures equivalent to the assertion descriptions shown in FIG. 2 and FIG. 3.

FIG. 2 shows an example as to an assertion property description made by the HDL description. As shown in FIG. 2, since a specification defined by a designer is expressed as “sequence”, operations over plural cycles are verified. In the example indicated in FIG. 2, the following specification is described: That is, after a “request” signal has become a logic value of “1”, a “grant” signal is generated after 1 to 3 cycles; the “request” signal is deasserted in the next cycle; and furthermore, the “grant” signal must be deasserted in the second next cycle.

FIG. 3 is an example as to an assertion designation which is inserted in an HDL description in order to check the assertion property of FIG. 2. FIG. 3 represents such an example that when an internal operation status of the designing subject circuit 3a becomes “FETCH”, the assertion property of FIG. 2 is checked.

Normally, an HDL description containing the assertion descriptions as shown in FIG. 2 and FIG. 3 is executed on a computer by an HDL simulator, or the like, so that an assertion verification is carried out. In contrast to the above-explained assertion verification, as indicated in FIG. 1, since the plurality of verification circuits 31_1 to 31_n, and also 32_1 to 32_k are mounted in the programmable circuit 1a, which correspond to the assertion descriptions, internal operations (internal signals) of the designing subject circuit 3a in the case that this designing subject circuit 3a is actually constituted as hardware can be verified in high precision.

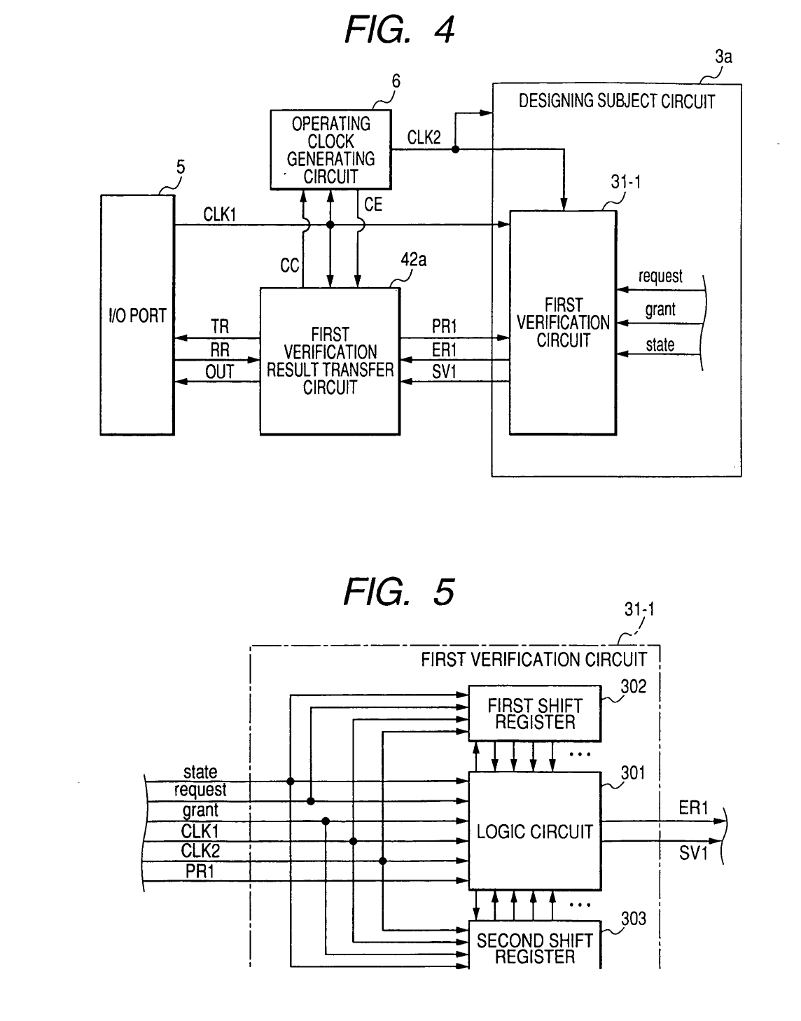

Next, referring now to FIG. 4, a description is made of summarized operations of the programmable circuit 1a shown in FIG. 1, while the I/O port 5, the first verification result transfer circuit 42a, and the first verification circuit 31_1 are exemplified. The I/O port 5 transfers a reference clock CLK1 supplied from the computer 2 shown in FIG. 1 to the first verification result transfer circuit 42a, the first verification circuit 31_1, and the operating clock producing circuit 6. Both the first and second data transfer circuits 41a and 41b, and both the first and second verification result transfer circuits 42a and 42b are operated in synchronism with the reference clock CLK1.

An operating clock generating circuit 6 generates an operating clock CLK2 in response to the reference clock CLK1. The designing subject circuit 3a is operated in synchronism with the operating clock CLK2. Although the first verification circuit 31_1 is operated in synchronism with the operating clock CLK2 until an error is detected, the first verification circuit 31_1 is operated in synchronism with the reference clock CLK1 after the error is detected. It should be understood that the operating clock CLK2 has been set to, for example, a frequency equal to that of the reference clock CLK1.

As a consequence, while the operation of the designing subject circuit 3a is stopped, both the first and second data transfer circuits 41a and 41b indicated in FIG. 1 can be prepared for receiving data from the C/C++ program and for transferring the data to the designing subject circuit 3a, and also, can transfer data received from the designing subject circuit 3a to the C/C++ program.

When the first verification circuit 31_1 shown in FIG. 4 detects an error, the first verification circuit 31_1 outputs an error detection notification signal ER1 to the first verification result transfer circuit 42a. When the first verification result transfer circuit 42a receives the error detection notification signal ER1, the first verification result transfer circuit 42a outputs an operating clock stop instruction signal CC with respect to the operating clock generating circuit 6. When the operating clock generating circuit 6 receives the operating clock stop instruction signal CC, the operating clock generating circuit 6 interrupts the generation of the operating clock CLK2. The operating clock generating circuit 6 outputs such an operating clock judging signal CE for indicating as to whether or not the operating clock CLK2 is stopped to the first verification result transfer circuit 42a.

Although the operating clock stop instruction signal CC is also outputted from the second verification result transfer circuit 42b shown in FIG. 1, the operating clock generating circuit 6 interrupts the generation of the operating clock CLK2 at a time instant when the operating clock stop instruction signal CC is outputted from any one of the first and second verification result transfer circuits 42a and 42b.

As a consequence, although the operation of the designing subject circuit 3a is stopped for a predetermined time period after the error has been detected, the first verification result transfer circuit 42a is continuously operated in synchronism with the reference clock CLK1. In the case that an error is detected in the verification subject signal, the first verification circuit 31_1 supplies the value SV1 of the verification subject signal when the error is detected to the first verification result transfer circuit 42a in synchronism with the reference clock CLK. While the operation of the designing subject circuit 3a is stopped, the first detection result transfer circuit 42a reads out the value SV1 of the verification subject signal when the error is detected from the first verification circuit 31_1, and transfers the read value SV1 of the verification subject signal to the computer 2.

When outputting of the value SV of the verification subject signal is completed with respect to the first verification result transfer circuit 42a, the first verification circuit 31_1 notifies such a message that outputting of the value SV1 of the verification subject signal has been completed to the first verification result transfer circuit 42a

In FIG. 4, the description is made in which there is one operating clock CLK2 for operating the designing subject circuit 3a, and the frequency of the operating clock CLK2 is identical to the frequency of the reference clock CLK1. Alternatively, plural pieces of the operating clocks CLK2 may be employed, and the frequency of the operating clock CLK2 may be different from that of the reference clock CLK1.

Next, a description is made of an internal structural example of the first verification circuit 31_1 indicated in FIG. 1 and FIG. 4 by referring to FIG. 5. The first verification circuit 31_1 is equipped with a logic circuit 301, a first shift register 301, and a second shift register 303. A “request” signal indicated in FIG. 5 corresponds to “request” of an assertion property example indicated in FIG. 2. Also, a “grant” signal represents “grant” of the assertion property example indicated in FIG. 2. Both the “request” signal and the “grant” signal correspond to verification subject signals, and a verification is carried out by the logic circuit 301.

A “state” signal corresponds to a signal indicative of an internal operation state of the designing subject circuit 3a, and corresponds to “state” of an assertion designation example indicated in FIG. 3. Operations as to the logic circuit 301, the first shift register 302, and the second shift register 303 are commenced, ended, and interrupted in response to the “state” signal. As one example, when the internal operation state of the designing subject circuit 3a becomes the “FETCH” state, the “state” signal becomes a logic value “1”, so that the assertion verification operation is commenced. In the case that the “state” signal becomes a logic value of “0”, the assertion verification operation is accomplished, or interrupted, so that the values held in the first shift register 302 and the second shift register 303 are reset.

The first shift register 302 acquires the “request” signal corresponding to the verification subject signal, and sequentially shifts the “request” signal in synchronism with the operating clock CLK2. The shifted “request” signal is inputted to the logic circuit 301. The second shift register 303 acquires the “grant” signal corresponding to the verification subject signal, and sequentially shifts the “grant” signal in synchronism with the operating clock CLK2. The shifted “grant” signal is inputted to the logic circuit 301. As a result, the logic circuit 301 can verify transitions among plural cycles between the “request” signal and the “grant” signal.

The logic circuit 301 detects an error based upon the respective values of the “request” signal and the “grant” signal. Concretely speaking, the logic circuit 301 judges as to whether or not the following specification can be satisfied. In this specification, after the “request” signal has become the logic value of “1”, the “grant” signal is generated after 1 cycle to 3 cycles; the “request” signal is deasserted in the next cycle; and furthermore, the “grant” signal is deasserted in the second next cycle. In the case that the specification cannot be satisfied, the logic circuit 301 outputs an error detection notification signal ER1 to the first verification result transfer circuit 42a represented in FIG. 1 and FIG. 4.

The first verification result transfer circuit 42a supplies a probe signal PR1 to the logic circuit 301, while this probe signal PR1 instructs to start reading operation of the signal values of the verification subject signals (“request” signal and “grant” signal) when the error is detected based upon the error detection notification signal ER1. In response to the probe signal PR1, the logic circuit 301 outputs the signal values SV1 of the verification subject signals (“request” signal and “grant” signal) when the error is detected to the first verification result transfer circuit 42a.

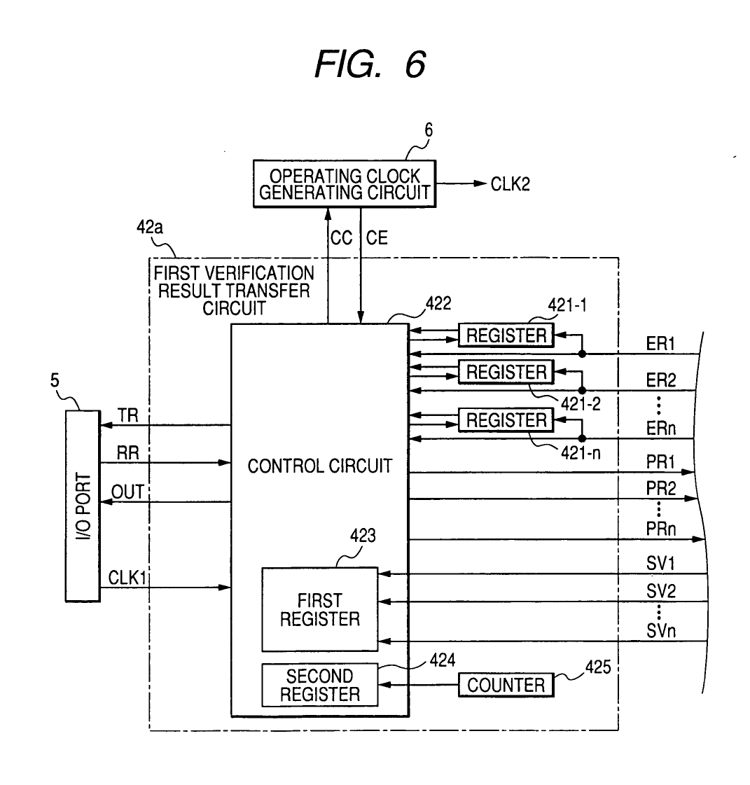

Next, a description is made of an internal structure example of the first verification result transfer circuit 42a shown in FIG. 1 and FIG. 4 with reference to FIG. 6. The first verification result transfer circuit 42a is provided with a control circuit 422, a counter 425, and a plurality (first to nth) registers 421_1 to 421_n. The control circuit 422 is provided with a first register 423 and a second register 424. The first register 423 temporarily holds a value of a verification subject signal when an error is detected. The second register 424 holds a count value of the counter 425.

To the control circuit 422, both error detection notification signals ER1 to ERn and verification subject signal values SV1 to SVn when an error is detected are inputted from the first to nth verification circuits 31_1 to 31_n indicated in FIG. 1. In the case that two, or more signals are produced among the error detection notification signals ER1 to ERn, the control circuit 422 discriminates a verification circuit which detects the error from other verification circuits with reference to the first to nth registers 421_1 to 421_n. When the reading operation is accomplished, the values held in the first to nth registers 421_1 and 421_n are reset.

In response to the error detection notification signals ER1 to ERn, the first verification result transfer circuit 42a outputs probe signals RP1 to PRn with respect to the first to nth verification circuits 31_1 to 31_n. In other words, in such a case that two, or more circuits among the first to nth verification circuits 31_1 to 31_n detect errors at the same time, the control circuit 422 performs reading operations of the verification subject signal values SV1 to SVn in a sequential manner by employing the probe signals PR1 to PRn.

A reception control signal RR and the reference clock CLK1 are inputted from the I/O port 5 shown in FIG. 1 and FIG. 4 to the control circuit 22. The control circuit 422 outputs both a transmission control signal TR and a verification result output signal OUT with respect to the I/O port 5. Since the reception control signal RR and the transmission control signal TR are transmitted and received between the I/O port 5 and the control circuit 422, the data transfer operation between the I/O port 5 and the control circuit 422 is controlled.

The counter 425 counts a cycle number of the operating clock CLK2 from the commencement of the simulation, and then, outputs the count value to the second register 424. Alternatively, the counter 425 may perform a counting operation based upon the reference clock CLK1 and an operating clock judging signal CE. Furthermore, while the counter 425 is not provided, a circuit may be alternatively arranged in such a manner that a clock number is derived from the SCE-MI application programming interface (API) of the C/C++ program.

As previously explained, the control circuit 422 performs the reading operations as to the verification subject signal values SV1 to SVn when the error is detected in response to the error detections of the first to nth verification circuits 31_1 to 31_n so as to acquire the cycle number from the commencement of the simulation until the error is detected. The information related to the verification subject signal values SV1 to SVn when the error is detected, and also the information related to the cycle number from the commencement of the simulation until the error is detected are transferred via the I/O port 5 to the computer 2 shown in FIG. 1 as the verification result.

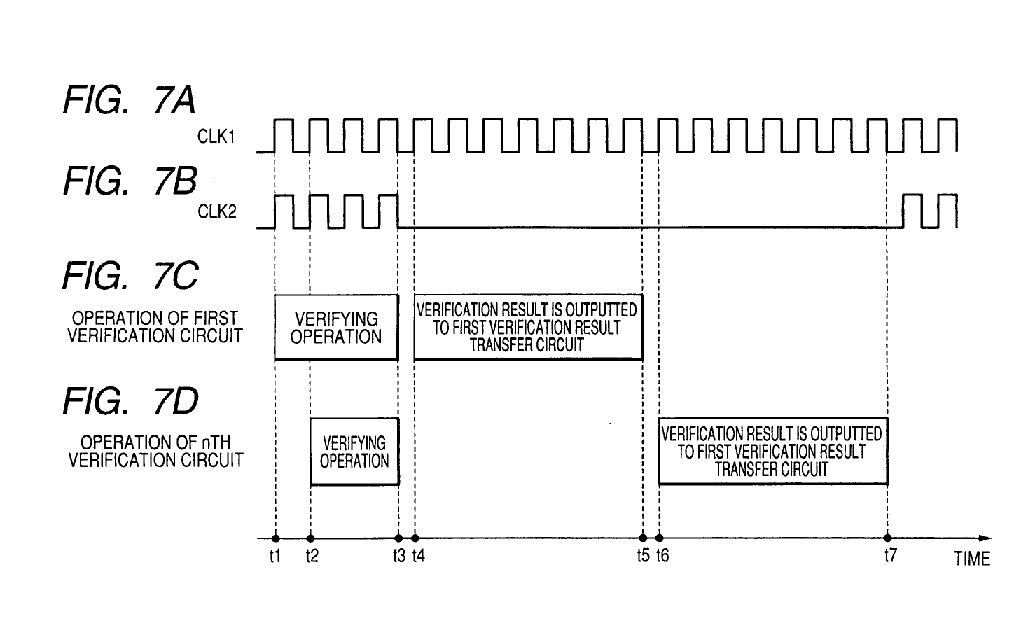

Next, referring to a time chart indicated in FIG. 7, operations of the programmable circuit 1a shown in FIG. 1 will now be described by exemplifying the first verification unit 31_1, the nth verification circuit 31_n, and the first verification result transfer circuit 42a. FIG. 7 indicates operations of the programmable circuit 1a in the case that both the first verification circuit 31_1 and the nth verification circuit 31_n detect an error at the same time.

At a time instant “t1” of FIGS. 7A to 7D, a verification operation of the first verification circuit 31_1 is commenced. At a time instant “t2”, a verification operation of the nth verification circuit 31_n is commenced.

It is assumed that at a time instant t3, both the first and nth verification circuits 31_1 and 31_n detect an error at the same time. When the error is detected, the operating clock generating circuit 6 indicated in FIG. 4 stops the generation of the operating clock CLK2 shown in FIG. 7B. When the generation of the operating clock CLK2 is stopped, although the operation of the designing subject circuit 3a shown in FIG. 1 is stopped, the first and nth verification circuits 31_1 and 31_n, and the first verification result transfer circuit 42a continue to be operated in synchronism with the reference clock CLK1 indicated in FIG. 7A.

Within a time period from a time instant t4 to a time instant t5, the first verification result transfer circuit 42a reads out a result of a verification by the first verification circuit 31_1. The verification result read from the first verification circuit 31_1 is transferred via the I/O port 5 to the computer 2.

Within a time period from a time instant “t6” to a time instant “t7”, the first verification result transfer circuit 42a reads out a result of a verification by the first verification circuit 31_n. The verification result read from the first verification circuit 31_n is transferred via the I/O port 5 to the computer 2.

As previously explained, in the case that the first and nth verification circuits 31_1 and 31_n detect the error at the same time, after the operating clock CLK2 is stopped, the verification result deriving operation by the first verification circuit 31_1 and the verification result reading operation by the nth verification circuit 31_n are carried out in the sequential manner.

Although the reference clock CLK1 are always and continuously operated in FIGS. 7A-7D, in such a case that the C/C++ program executed on the computer 2 and the programmable circuit 1a transmit and receive data via the PCI bus, there are some cases that the reference clock CLK1 is stopped.

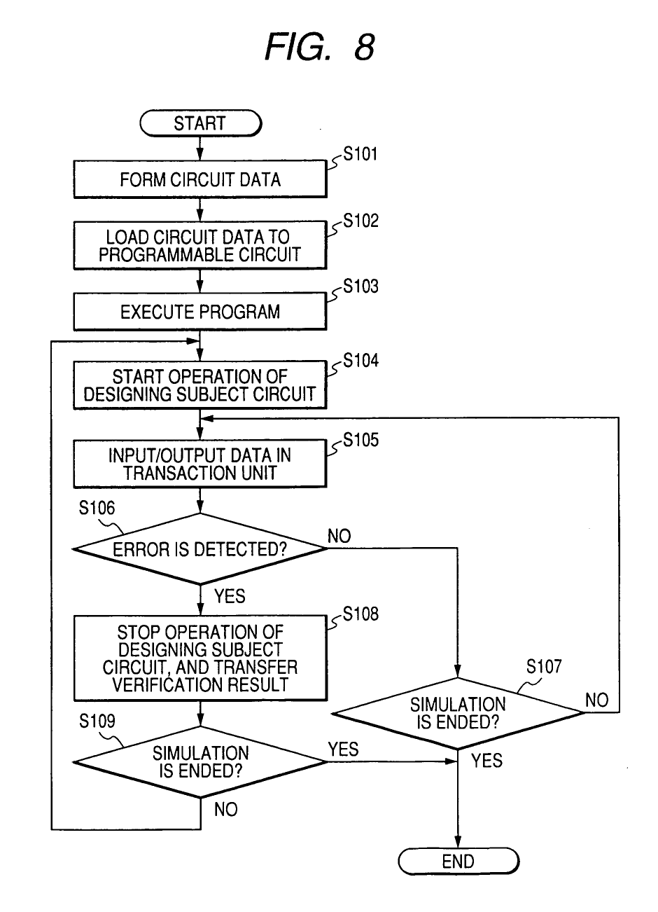

Next, a simulation method according to the first embodiment will now be described with reference to a flow chart shown in FIG. 8. It should also be understood that the below-mentioned description is made of such a case that simultaneous occurrences of errors when verification (simulation) is carried out are not considered.

In a step S101 of the flow chart, the computer 2 shown in FIG. 1 forms circuit data based upon an operating description. Concretely speaking, an HDL description is formed by executing a high grade synthesization, or the like from the operating description. An assertion description is inserted into the HDL description. Circuit data (net list) is formed by logically synthesizing the HDL descriptions with each other. With respect to the assertion description, for instance, the circuit data for the assertion description is formed by acquiring the circuit data corresponding to the assertion description from a previously prepared library.

In a step S102, the circuit data formed in the step S101 is converted into a predetermined data format, and thereafter, the data-formatted circuit data is loaded to the programmable circuit 1a. Also, in a step S103, the computer 2 executes the C/C++ program which performs the temporally unlimited operation.

In a step S104, a cycle operation of the designing subject circuit 3a is commenced.

In a step S105, a data transfer circuit performs a data transfer operation between the computer 2 and the designing subject circuit 3a in the unit of a transaction.

In a step S105, a plurality of verification circuits 31_1 to 31_n, and 32_1 to 32_k monitor internal circuits of the designing subject circuit 3a at predetermined timing, and verify as to whether or not the operation of the designing subject circuit 3a can satisfy the specification. In the case that the designing subject circuit 3a cannot satisfy the specification but an error is detected, the process operation is advanced to a step S108. When the error is not detected, the process operation is advanced to a step S107.

When a judgement is made that the simulation is accomplished in the step 107, the simulation is accomplished. To the contrary, if a judgement is made that the simulation is not accomplished in the step 107, then the process operation is returned to the step S105.

In a step S108, the operation of the designing subject circuit 3a is stopped. Also, the verification result is transferred to the compute 2 for a time period during which the operation of the designing subject circuit 3a is stopped.

When a judgement is made that the simulation is accomplished in a step S109, the simulation is ended. To the contrary, in the case that a judgement is made that the simulation is not accomplished in the step S107, the process operation is returned to the step S104 in which the cycle operation of the designing subject circuit 3a is restarted.

As previously described in detail, in accordance with the first embodiment, also in the cooperative simulation of the transaction level using the programmable circuit 1a, the assertion verification can be carried out. As a consequence, the monitoring characteristic as to the internal signals of the designing subject circuit 3a mounted on the programmable circuit 1a can be sufficiently increased, so that the design quality (simulation quality) can be improved. Moreover, the data transfer operation between the designing subject circuit 3a and the C/C++ program is performed in the unit of the transaction, so that the simulation can be carried out in the high speed and the time required for the simulation can be shortened.

### First Modification of First Embodiment

The above-described first embodiment has explained such an example that the operation of the designing subject circuit 3a is stopped immediately after the error detection is notified. However, as a first modification of the first embodiment, the operation of the designing subject circuit 3a may be stopped after a constant cycle has elapsed from the notification of the error detection. As a result, after a certain error is detected, another error occurred within a constant cycle time period may also be detected.

The operating clock generating circuit 6 indicated in FIG. 4 counts the reference clock CLK1 at such a time instant when the operating clock generating circuit 6 receives, for instance, the operating clock stop instruction signal CC from the first verification result transfer circuit 42a, and continues to generate the operating clock CLK2 until the count value becomes a constant value.

Each of the first and second verification result transfer circuits 42a and 42b shown in FIG. 1 sequentially reads out values of verification subject signals when an error is detected with respect to the error detected within the constant cycle time period after the error detection has been notified.

As previously explained, in accordance with the first modification of the first embodiment, the designing subject circuit 3a is operated within the constant cycle time period after a certain error has been detected, so that another error can be detected within the above-described constant cycle time period.

### Section Modification of First Embodiment

As a second modification of the first embodiment, such an example will now be explained. That is, before circuit data with respect to the programmable circuit 1a is loaded, such verification circuits having higher possibilities at which an error can be detected at the same time among the plural verification circuits 31_1 to 31_n, and 32_1 to 32_k are allocated to different verification result transfer circuits.

In the case that the verification result transfer circuit 42a shown in FIG. 1 reads out verification results of the plural verification circuits 31_1 to 31_n, simultaneous occurrence frequencies of an error when a simulation is executed are estimated so that such verification circuits having higher possibilities at which the error can be detected at the same time are allocated to different verification result transfer circuits.

For instance, verification circuits in which signals to be verified are identical to each other may be judged that possibilities are high at which the error can be detected at the same time. As a consequence, it is preferable that the verification circuits in which the signals to be verified are identical to each other are allocated to different verification result transfer circuits.

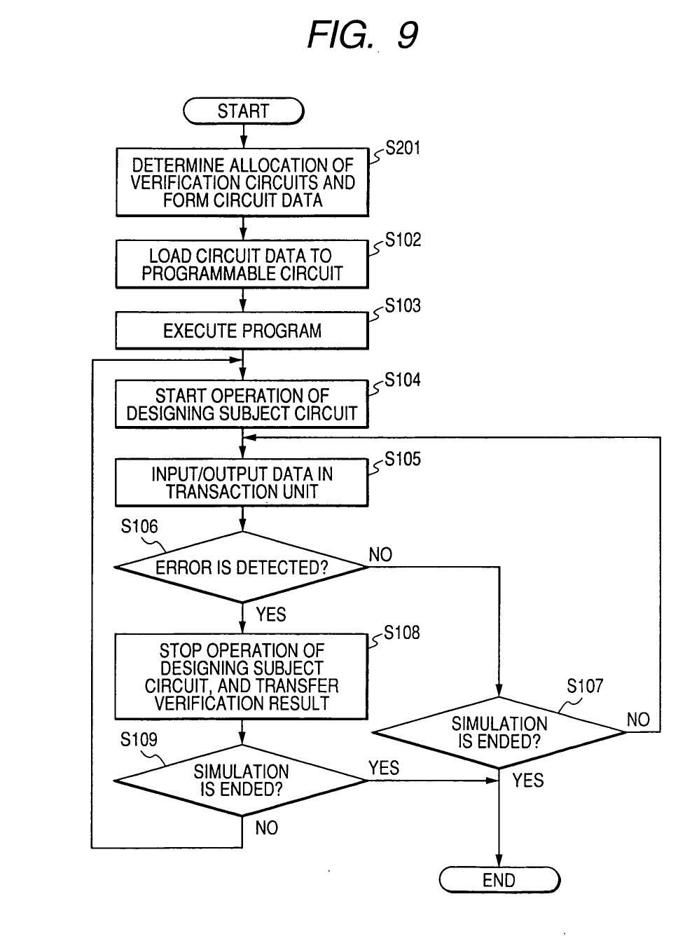

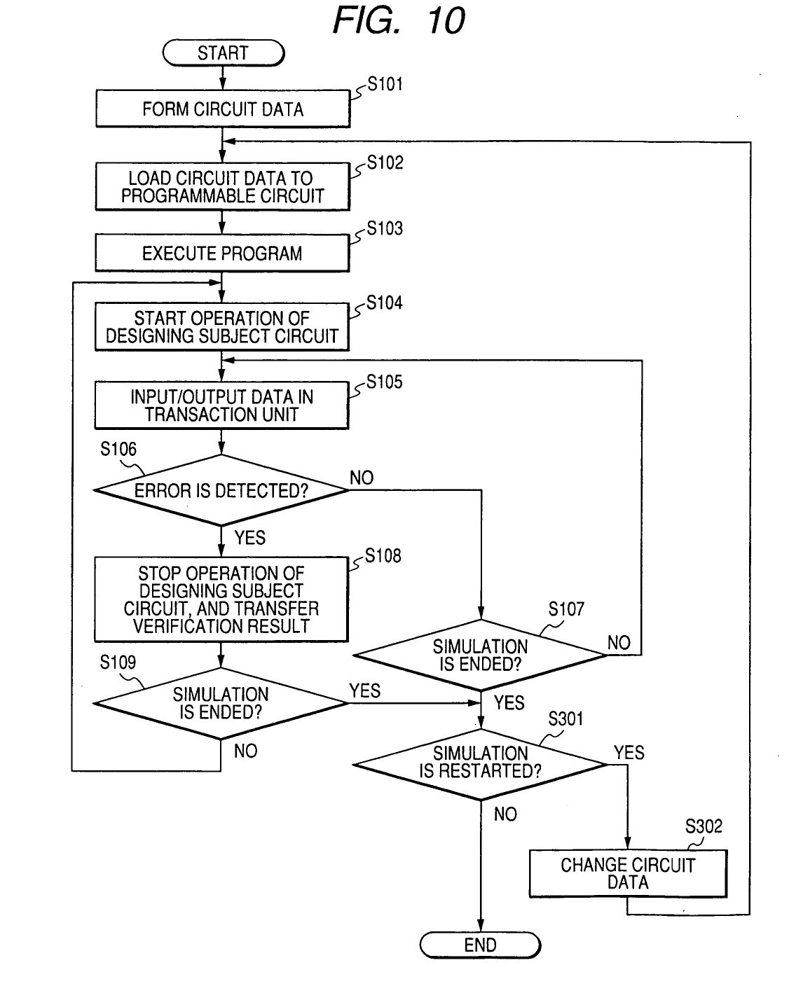

Next, a simulation method according to the second modification of the first embodiment will now be explained with reference to a flow chart shown in FIG. 9. It should be understood that as to similar process operations to those of the flow chart shown in FIG. 8, overlapped descriptions are omitted.

In a step S201 of the flow chart shown in FIG. 9, the computer 2 shown in FIG. 1 forms circuit data based upon an operating description. An assertion description is inserted into the HDL description. In addition, the computer 2 analyzes assertion descriptions inserted in the HDL description so as to retrieve such assertion descriptions that signals to be verified are identical to each other from a plurality of assertion descriptions.

Also, the computer 2 forms circuit data (net list) by logically synthesizing the HDL descriptions with each other. With respect to the assertion description, for instance, the circuit data for the assertion description is formed by acquiring the circuit data corresponding to the assertion description from a previously prepared library. In this case, the circuit data of the assertion descriptions in which the signals to be verified are identical to each other are allocated to such circuit data of the different verification result transfer circuits.

In a step S102, the circuit data formed in the step S201 is loaded in the programmable circuit 1a. Process operations subsequent to the step S102 are similar to those indicated in FIG. 8.

As previously explained, in accordance with the second modification of the first embodiment, before the circuit data is loaded in the programmable circuit 1a, since the correspondence relationship between the verification circuits and the verification result transfer circuits is optimized, in such a case that the plurality of verification circuits detect the error at the same time, the transfer operations of the verification results can be accomplished within a short time.

### Third Modification of First Embodiment

As a third modification of the first embodiment of the present invention, such an example will now be explained. That is, verification circuits having higher possibilities at which an error is detected at the same time are allocated to different verification result transfer circuits in accordance with a method different from that of the above-explained second modification of the first embodiment. Concretely speaking, two, or more verification circuits which detect the error at the same time are allocated to the different verification result transfer circuits based upon a result obtained by that a simulation is once performed.

Next, a simulation method according to the third modification of the first embodiment will now be explained with reference to a flow chart shown in FIG. 10. It should be understood that as to similar process operations to those of the flow chart shown in FIG. 8, overlapped descriptions are omitted.

When a judgement is made that a first simulation is accomplished in a step S107, or a step S109, the process operation is advanced to a step S301. In the step S301, a judgement is made as to whether or not the simulation is restarted in the step S301. In the case that it is so judged that the simulation is restarted, the process operation is advanced to a step S302. When it is so judged that the simulation is not restarted, the simulation is accomplished.

In the step S302, two, or more circuits of verification circuits are specified which detect the error of the same time during the first simulation, and the circuit data formed in the step S101 is changed in such a manner that two, or more circuits of the specified verification circuits are allocated to the different verification result transfer circuits. When the circuit data is changed, the process operation is returned to the step S102.

As previously explained, in accordance with the third modification of the first embodiment, two, or more circuits of the verification circuits which detect the error at the same time are allocated to the different verification result transfer circuit based upon the result obtained by that the simulation is once executed, so that the correspondence relationships between the verification circuits and the verification result transfer circuit can be optimized.

### Second Embodiment

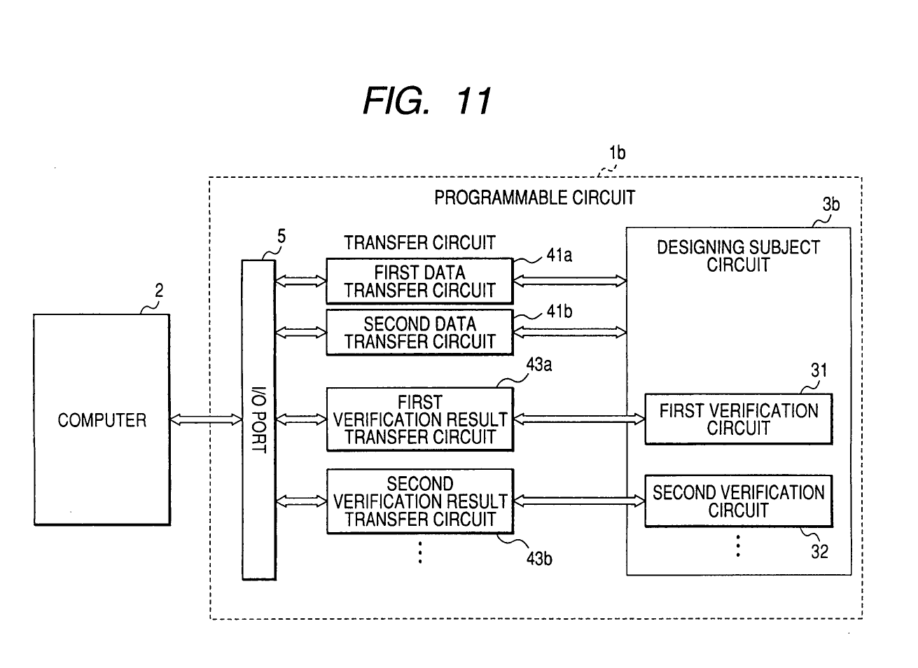

A simulation apparatus according to a second embodiment of the present invention has a different point from that of FIG. 1. That is, as indicated in FIG. 11, in a programmable circuit 1b, one verification result transfer circuit is allocated to one verification circuit. In other words, a first verification result transfer circuit 43a shown in FIG. 11 reads out only a result of verification obtained from a first verification circuit 31. Similarly, a second verification result transfer circuit 43b shown in FIG. 11 reads out only a result of verification obtained from a second verification circuit 32. Other arrangements of the above-explained simulation apparatus are similar to the arrangements of the simulation apparatus shown in FIG. 1.

In the simulation apparatus indicated in FIG. 1, the following case has been explained. That is, while the first to nth verification circuits 31_1 to 31_n are connected to the first verification result transfer circuit 42a, in such a case that the error occurs at the same time in the first to nth verification circuits 31_1 to 31_n, the first verification result transfer circuit 42a sequentially reads out the verification results. On the other hand, in the simulation apparatus shown in FIG. 11, since a plurality of verification result transfer circuits 43a, 43b, - - - , are allocated to a plurality of verification circuits 31, 32, - - - , a time required for transferring verification results when the error is simultaneously produced can be shortened.

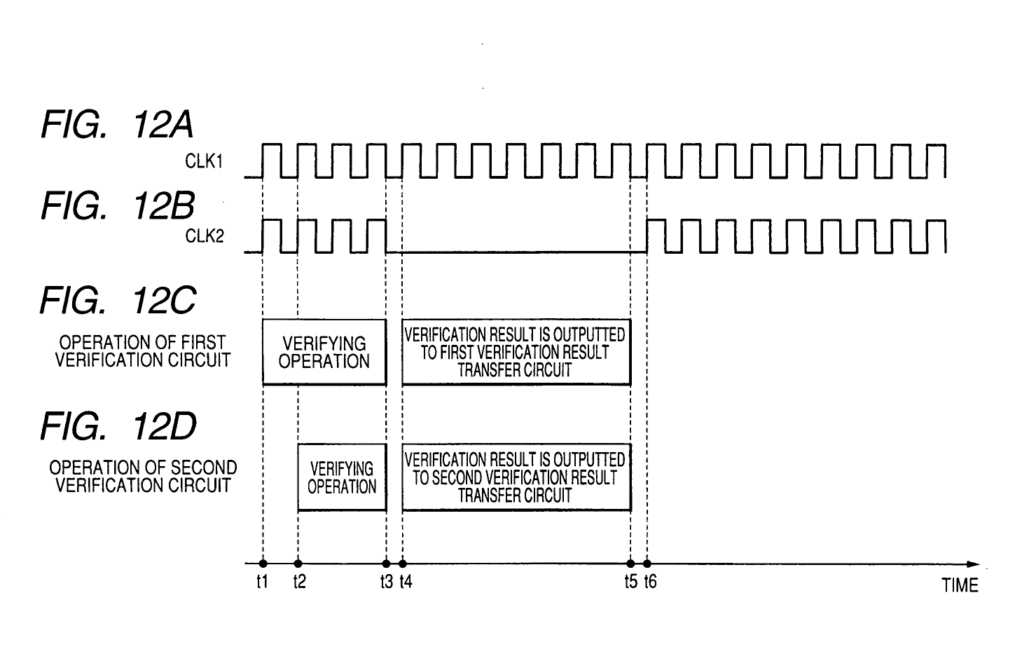

Next, referring to a time chart indicated in FIGS. 12A-12D, operations of the programmable circuit 1b shown in FIG. 11 will now be described by exemplifying the first verification unit 31, the second verification circuit 32, the first verification result transfer circuit 43a, and the second verification result transfer circuit 43b. FIG. 12A-12D show operations of the programmable circuit 1b in the case that both the first verification circuit 31 and the second verification circuit 32 detect an error at the same time. As to similar operations to those of the programmable circuit 1a shown in FIG. 1, overlapped descriptions are omitted.

It is assumed that at a time instant t3 of FIG. 12, both the first and second verification circuits 31 and 32 detect an error at the same time. When the error is detected, although the operation of the designing subject circuit 3b shown in FIG. 11 is stopped, the first and second verification circuits 31 and 32, the first verification result transfer circuit 43a and the second verification result transfer circuit 43b continue to be operated in synchronism with the reference clock CLK1 indicated in FIG. 12A.

Within a time period from a time instant t4 to a time instant t5, the first verification result transfer circuit 43a reads out a result of a verification by the first verification circuit 31. The verification result read from the first verification circuit 31 is transferred via the I/O port 5 to the computer 2. Similarly within the time period from the time instant t4 to the time instant t5, the second verification result transfer circuit 43b reads out a result of a verification by the second verification circuit 32. The verification result read from the second verification circuit 32 is transferred via the I/O port 5 to the computer 2.

As previously explained, in accordance with the second embodiment, in such a case that the plural verification circuits 31, 32, - - - , detect the error at the same time, the verification results can be transferred to the computer 2 within the short time. As a result, the overhead required for reading the verification results can be reduced, and the overall simulation time can be shortened.

### Third Embodiment

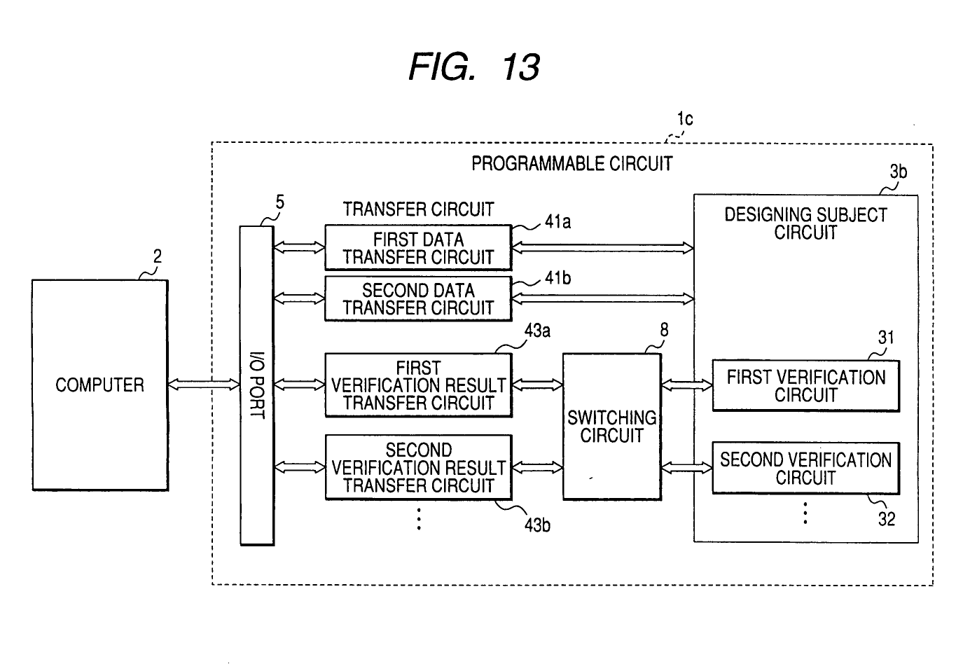

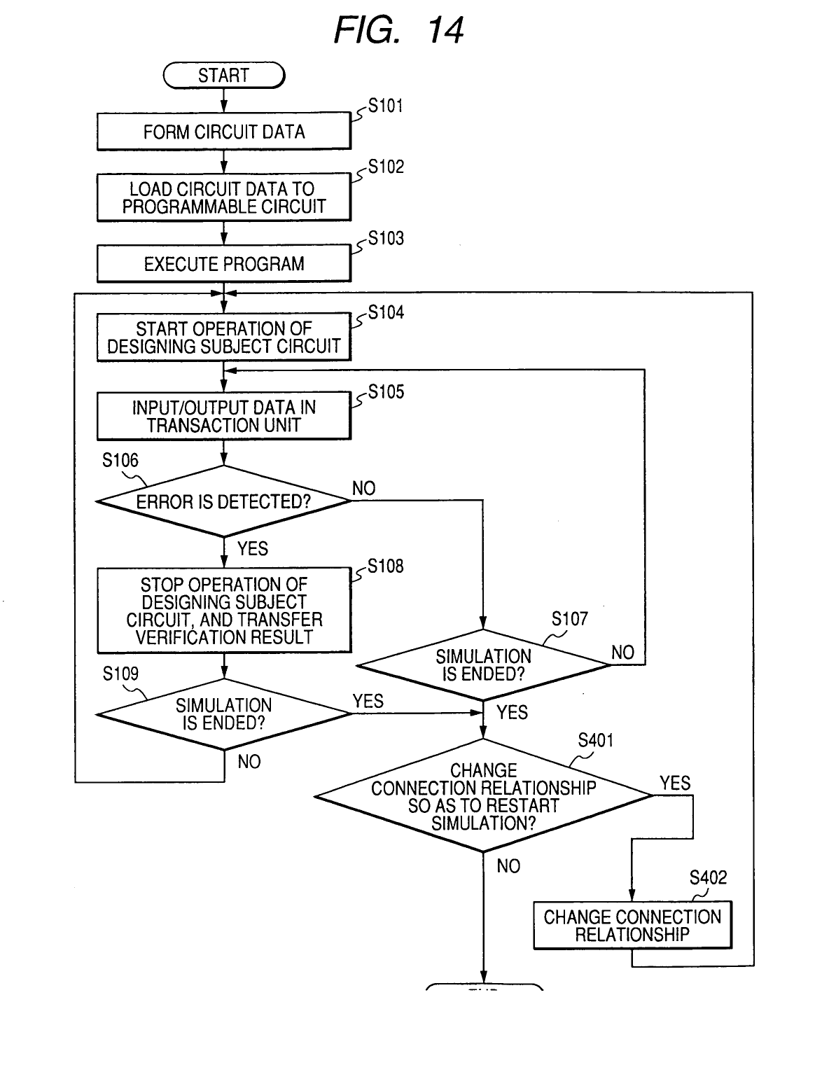

As represented in FIG. 13, a simulation apparatus, according to a third embodiment of the present invention, owns the following different point from the simulation apparatus of FIG. 1. That is, a switching circuit 8 is provided which is connected between a plurality of verification circuits 31, 32, - - - , and a plurality of verification result transfer circuits 43a, 43b, - - - . For instance, the switching circuit 8 switches connection relationships between the plurality of verification result transfer circuits 31, 32, - - - , and the plurality of verification circuits 43a, 43b, - - - , in response to a switching control signal which is transferred from the computer 2 via the I/O port 5.

As a consequence, even after the circuit data has been loaded in a programmable circuit 1c, the connection relationship between the plurality of verification circuits 31, 32, - - - , and the plurality of verification result transfer circuits 43a, 43b, - - - , can be switched.

For instance, the connection relationship for connecting the first verification circuit 31 to any one of the first and second verification result transfer circuits 43a and 43b may be arbitrarily changed before a simulation is commenced, or when the simulation is interrupted. Similarly, the connection relationship for connecting the second verification circuit 32 to any one of the first and second verification result transfer circuits 43a and 43b may be arbitrarily changed before a simulation is commenced, or when the simulation is interrupted.

When the connection relationship between the plurality of verification circuits 31, 32, - - - , and the plurality of verification result transfer circuits 43a, 43b, - - - is switched, in the computer 2, a correspondence table (cross reference) between titles of signals to be verified and the plurality of verification result transfer circuits 43a, 43b, - - - , must be changed.

Next, a simulation method according to the third embodiment will now be explained with reference to a flow chart shown in FIG. 14. It should be noted that a description is made of such a case that the connection relationship between the plurality of verification circuits 31, 32, - - - , and the plurality of verification result transfer circuits 43a, 43b, - - - , is switched based upon a result obtained after a simulation is once executed. Also, as to similar process operations to those of the flow chart indicated in FIG. 8, overlapped explanations thereof are omitted.

In a step S401, the computer 2 judges as to whether or not the simulation is restarted by switching the connection relationship between the plurality of verification circuits 31, 32, - - - , and the plurality of verification result transfer circuits 43a, 43b, - - - . In the case that the computer 2 judges that the connection relationship is switched so as to restart the simulation, the process operation is advanced to a step S402. In the case that the computer 2 judges that the connection relationship is switched so as not to restart the simulation, the simulation is accomplished.

In the step S402, the computer 2 transmits a switching control signal via the I/O port 5 to the switching circuit 8, so that the connection relationship between the plurality of verification circuits 31, 32, - - - , and the plurality of verification result transfer circuits 43a, 43b, - - - , is switched.

As previously explained, in accordance with the third embodiment, the connection relationship between the plurality of verification circuits 31, 32, - - - , and the plurality of verification result transfer circuits 43a, 43b, - - - , can be dynamically reconstructed.

### Other Embodiments

While the present invention has been described based upon the first to third embodiments, the descriptions and the drawings which constitute a portion of this disclosure do not restrict the present invention. It becomes apparent that various substituted embodiments, embodiments and operating techniques may be easily conceived based upon this disclosure by ordinarily skilled engineers.

The above-embodiments have described examples in which a designing subject circuit 3a is mounted on the programmable circuit 1a. Alternatively, a plurality of designing subject circuits may be mounted on the programmable circuit 1a.

Such an example has been exemplified that the cooperative simulation is carried out by using one programmable circuit. Alternatively, a plurality of programmable circuits may be used. Since the plural programmable circuits are used, a simulation as to larger-scaled hardware may be realized.

The first modification of the above-described first embodiment has explained an example in which the operation of the designing subject circuit 3a is stopped after the constant cycle period has passed from the notification of the error detecting operation. Alternatively, the second and third embodiments may employ such an arrangement that the operation of the designing subject circuit 3a is stopped after the constant cycle period has passed from the notification of the error detecting operation.

According to the above-embodiments, it is possible to provide the simulation apparatus and the simulation method, capable of improving the simulation quality as to the cooperative simulation of both the hardware and the software.

As previously described, the present invention may include various embodiments which are not described in the specification.

What is claimed is:

1. A simulation apparatus comprising:
a computer configured to execute a program which is formed as an operating description having no temporal restriction; a programmable circuit configured to be on which a designing object circuit configured to perform a cycle operation is mounted, the programmable circuit comprising;
a data transfer circuit configured to transfer data between the computer and the designing subject circuit in a unit of a transaction;
a verification circuit configured to verify as to whether or not operation of the designing subject circuit satisfies a specification and notifying a detection of an error when the operation of the designing subject circuit does not satisfy the specification; and
a verification result transfer circuit configured to temporarily stop the operation of the designing subject circuit in the case that the detection of the error is notified so as to transfer a verification result obtained by the verification circuit to the computer.

2. A simulation apparatus according to claim 1, wherein a cycle operation is synchronized with a clock.

3. A simulation apparatus according claim 1, wherein the computer is configured to execute the program which is formed as an operating description which is not synchronizes with a clock.

4. A simulation apparatus according to claim 1, wherein the program executed by the computer is describe by either a C language or a C++ language.

5. A simulation apparatus according to claim 1, wherein the unit of the transaction is a unit of plural clocks.

6. A simulation apparatus according to claim 1 wherein, when a plurality of verification circuits detect the error at the same time, the verification result transfer circuit sequentially reads out verification results obtained by the respective verification circuits.

7. A simulation apparatus according to claim 6, wherein each verification result includes at least one among presence/absence of the error detection; a value of a verifying subject signal where the errors are detected; and information as to a total number of the cycle operation of simulation until the errors are detected;

8. A simulation apparatus according to claim 1 wherein a plurality of the verification circuits and the verification result transfer circuits are provided; and
wherein a total number of the verification circuits is equal to a total number of the verification result transfer circuits.

9. A simulation apparatus according to claim 8, wherein each verification circuit is assigned to each verification result transfer circuit, based on pre-set simultaneous occurrence frequencies of the error when a simulation is executed.

10. A simulation apparatus according to claim 9, wherein verification circuits having high possibility at which the error can be detected are assigned to different verification is configured to result transfer circuits.

11. A simulation apparatus according to claim 8, further comprising;
a switching circuit configured to switch connection relationships between the plurality of verification result transfer circuits and the plurality of verification circuits.

12. A simulation apparatus as claimed in claim 1, wherein the verification result transfer circuit temporarily stops the operation of the designing subject circuit after a constant cycle time period elapses since the detection of the error is notified.

13. A simulation method comprising:
mounting a designing subject circuit which performs a cycle operation on a programmable circuit;
executing a program which is formed as an operating description having no temporal restriction on a computer;
transferring data between the computer and the designing subject circuit in the unit of a transaction;
verifying as to whether or not operation of the designing subject circuit satisfies a specification;
notifying a detection of an error in the case that the operation of the designing subject circuit does not satisfy the specification;
stopping the operation of the designing subject circuit temporarily in case that the detection of the error is notified; and
transferring to the computer, a result of the verification for indicating as to whether or not the operation of the designing subject circuit satisfies the specification.

14. A simulation method according to claim 13, wherein the cycle operation is synchronized with a clock.

15. A simulation method according claim 13, wherein the computer is configured to execute the program which is formed as an operating description which is not synchronizes with a clock.

16. A simulation method according to claim 13, wherein the program executed by the computer is describe by either a C language or a C++ language.

17. A simulation method according to claim 13, comprising;
sequentially reading out verification results obtained by the respective verification circuits, when a plurality of verification circuits detect the error at the same time.

18. A simulation method according to claim 17, wherein each verification result includes at least one among presence/absence of the error detection; a value of a verifying subject signal where the errors are detected; and information as to a total number of the cycle operation of simulation until the errors are detected.

19. A simulation method according to claim 13, wherein a plurality of the verification circuits and the verification result transfer circuits are provided; and
wherein a total number of the verification circuits is equal to a total number of the verification result transfer circuits.

20. A simulation method according to claim 19, wherein each verification circuit is assigned to each verification result transfer circuit, based on pre-set simultaneous occurrence frequencies of the error when a simulation is executed.
